(19) United States
(12) Patent Application Publication
(10) Pub. No.: US 2007/0215557 A1
(43) Pub. Date: Sep. 20, 2007

(54) Grease processing unit for wastewater treatment

(75) Inventors: Kevin L. Gallegos, Grand Junction, CO (US); Michael J. Kruckenberg, Grand Junction, CO (US); Larry Dean Brown, Grand Junction, CO (US); Ronald Hill, Grand Junction, CO (US); Daniel Tonello, Fruita, CO (US); Jack Beach, Loma, CO (US); Timothy Morse, Grand Junction, CO (US); Edwin Tankersley, Palisade, CO (US); Charles Bosshardt, Fruita, CO (US); Timothy Boyles, Grand Junction, CO (US); S. Bret Guillory, Grand Junction, CO (US)

Correspondence Address: BLAKELY SOKOLOFF TAYLOR & ZAFMAN, 1279 OAKMEAD PARKWAY, SUNNYVALE, CA, 94085-4040, US

(73) Assignee: City of Grand Junction

(21) Appl. No.: 11/510,053

(22) Filed: Aug. 24, 2006

Related U.S. Application Data
(60) Provisional application No. 60/784,196, filed on Mar. 20, 2006.

(51) Int. Cl. B01D 17/00

(52) U.S. Cl. 210/744; 210/776; 210/97; 210/540; 210/920

(57) ABSTRACT

A method and apparatus for a grease processing unit for wastewater treatment. An embodiment of a grease processing unit includes a tank to hold influent. The tank has a top, a bottom, and one or more sides, and the influent is a mixture of grease and water. There is a first inlet in a side of the tank to allow influent to be pumped into the tank, and a second inlet in a side of the tank to allow water into the tank. The tank has an outlet in a side of the tank, where the outlet allows effluent to be released out of the tank. The grease separation unit also includes a control unit, the control unit to control the operation of the grease processing unit.

### RELATED APPLICATION

This application claims the benefit of provisional application Ser. No. 60/784,196, filed Mar. 20, 2006.

### FIELD

An embodiment of the invention relates to water treatment in general, and more specifically to a grease processing unit for wastewater treatment.

### BACKGROUND

In wastewater treatment, grease removal is an essential task because of the large amount of grease that is produced and that can potentially reach the wastewater system. The output of many facilities, particularly restaurants and other related food processing operations, includes grease that contains a substantial amount of water. In order to process the wastewater for further use and to dispose of or reprocess the grease, it is necessary to efficiently and effectively separate effluent into concentrated grease for disposal and wastewater containing relatively little grease for further processing.

Conventional systems to remove grease from waster water are generally complicated, space and labor intensive, and expensive in operation. Conventional systems may include “vacuum filter” systems, which utilize a rotating cylinder with a fabric mat, with a scraper unit that scrapes the grease off the fabric mat. Another conventional system is a “filter box”, a large unit (generally a freight car sized unit) that includes filters to trap the grease, with the filters being cleared periodically to remove the grease.

Conventional skimming operations also may occur in a wastewater treatment plant, in which influent is, for example, dumped into a main clarifying pool or tank, where the concentrated grease may be scraped or scooped off. However, such a skimming system requires that the grease-laden influent enter the main wastewater treatment system before the grease is removed. The use of the main wastewater treatment plant means that a significant amount of grease needs to be removed from a very large amount of water, and may further require that this grease be transported away from the wastewater treatment plant for further concentration before disposal or reprocessing.

### SUMMARY OF THE INVENTION

A method and apparatus for a grease processing unit for wastewater treatment.

In one aspect of the invention, a grease processing unit includes a tank to hold influent. The tank has a top, a bottom, and one or more sides, and the influent is a mixture of grease and water. There is a first inlet in a side of the tank to allow influent to be pumped into the tank, and a second inlet in a side of the tank to allow water into the tank. The tank has an outlet in a side of the tank, where the outlet allows effluent to be released from the tank. The grease separation unit also includes a control unit, the control unit to control the operation of the grease processing unit.

### BRIEF DESCRIPTION OF THE DRAWINGS

The invention may be best understood by referring to the following description and accompanying drawings that are used to illustrate embodiments of the invention. In the drawings:

FIG. 1 is an illustration of an embodiment of a wastewater treatment system;

FIG. 2 illustrates an embodiment of a grease removal operation;

FIG. 3 is an illustration of an embodiment of a grease removal unit for wastewater treatment;

FIG. 4 is an illustration an embodiment of a user control interface for a grease removal unit;

FIG. 5 is a flowchart to illustrate a process for removing grease from wastewater; and

FIG. 6 is an illustration of a control unit that may be utilized in an embodiment.

### DETAILED DESCRIPTION

A method and apparatus are described for a grease processing unit for wastewater treatment.

As used herein, “influent” means a received mixture containing grease and water. The influent may contain other material as well. Influent includes waste output of restaurants and similar operations, containing grease from food preparation. As used herein, “effluent” means wastewater and associated materials that is released from grease separation, with the effluent then generally being directed to a wastewater treatment facility.

As used herein, “grease” means fatty oils, particularly those produced in the process of food production or other related operations.

As used herein, “wastewater” means water that requires treatment before reuse. Treatment may include filtering, purification, and other processes. Wastewater includes common sewage, runoff, and other collected water.

As used herein, “wastewater treatment plant” means a facility or facilities for the treatment or purification of wastewater. A wastewater treatment plant may utilize any known water treatment processes.

In an embodiment of the invention, a grease removal unit is provided as a stand alone unit that may be separated from a wastewater treatment plant. In an embodiment, the grease removal unit can be constructed in any physical location. An embodiment of the invention does not need to be located near a wastewater treatment plant, and thus units can be located in various convenient locations for grease processing.

In an embodiment of the invention, a grease removal unit receives influent, the influent containing grease and water, and possibly other materials. The unit handles the influent reception process automatically. The unit then allows the grease to separate in a layer at the top of the unit for removal. The unit further raises the grease layer to the top of the unit using hydraulic pressure, and scrapes or skims concentrated grease from the top of the unit directly into mobile removal vehicles or units for disposal.

An embodiment of a grease removal unit requires a relatively small amount of land, or footprint, in comparison with alternative technologies. In one particular example, a unit may practically be constructed in a location requiring a space of only 25 feet by 25 feet, plus additional room sufficient for vehicles such as tanker trucks to deliver grease influent for processing and for vehicles such as dump trucks to receive the concentrated grease for removal.

In an embodiment of the invention, a grease removal unit may be operated with minimal labor, with many of the operations being automatic. A unit may accomplish most of the separation processing of influent automatically without input from a human operator. In one embodiment, human intervention is generally only required when the grease is to be skimmed for removal from the unit, with a single operator being capable of observing and controlling the operation of the grease removal unit in skimming operations.

In an embodiment of the invention, a grease removal unit includes a holding tank to hold influent for separation of grease and wastewater. In an embodiment, the holding tank has an opening at the top of the tank. The grease tank may be constructed as a square or rectangular tank with an open top, but embodiments of the invention are not limited to any particular shape. When allowed to separate, the grease in the tank will float to the surface of the wastewater and form a “grease cap”. The unit further includes a scraping or skimming unit to scrape concentrated grease in the grease cap from the top of the tank for removal. The unit further includes one or more control units or programmable logic to control the operation of the grease removal unit, both for automatic operations and for operations with human intervention. The unit further may include one or more sensors to detect the details of the operation and make certain the operation is proceeding within required limits or tolerances.

In an embodiment of the invention, a grease removal unit accepts truckloads of influent, which may be produced by restaurants or other food production operations, although embodiments of the invention are not limited to any particular production source. The influent is generally predominantly grease and water, with other solid and liquid matter potentially being contained in the influent. For delivery of influent, tank haulers or other similar vehicles may connect to the unit by a hose or other similar device, pump the influent from the vehicle into the holding tank of the unit, and drive away after completion of the delivery. In an embodiment of the invention, operation of the grease removal unit in influent delivery is automatic and operates to allow separation of grease and wastewater while preventing overfilling of the unit.

In an embodiment of the invention, when a truckload of influent is delivered to the unit, the influent is pumped into the holding tank of the unit through an influent inlet. After delivery of the influent, the unit automatically waits a certain amount of time (for example, fifteen minutes) to allow the contents in the tank to separate and allow the grease to begin to float to the surface of the holding tank. The unit then opens a outlet (or release valve) to allow effluent at the most clear portion of the tank, generally towards the bottom of the tank, to be decanted into a wastewater treatment system. In an embodiment of the invention, if too much influent is pumped into the tank at any time, the unit detects this condition and opens the release valve immediately to release the excess contents from the unit, and thus preventing overflow of the unit while retaining the correct amount of material in the unit for processing.

Periodically (for example, on a weekly basis) the contents of the grease removal unit are allowed to separate for a certain amount of time (such as a period of a day) to allow the grease to float to the top of the holding tank and to separate as much water from the grease as possible. During this time, no influent deliveries to the unit are allowed in order to maximize separation. The time period provided for separation allows the grease in the grease cap to reach high concentration levels for removal.

When a sufficient amount of grease has been received by the unit and after a period for separation of contents has elapsed, concentrated grease may be removed from the holding tank using a skimming or scraping process. In an embodiment of the invention, hydraulic pressure is used to raise the layer of grease sufficiently high to skim off the most concentrated grease from the grease cap at the top of the tank. In this process, the release valve is closed (thereby overriding the overflow mechanism), and water is pumped or released into the unit to force the grease cap high enough to allow a skimmer to skim the top of the grease cap. In an embodiment, an operator can control the operation of the unit to skim the very top of the grease cap, which contains the most concentrated grease. The operator can stop the skimming operation when the grease at the top of the tank is no longer sufficiently concentrated, the grease still containing too much water, and thus should be retained in the unit for further concentration. When enough grease has been skimmed from the grease cap, the release valve is opened and the unit releases enough effluent to return the contents of the holding tank to a working level. At this point, the unit may again begin to accept more shipments of influent for separation.

In an embodiment of the invention, the grease is brought to the skimmer using only hydraulic pressure—the grease is raised by pumping water into the unit, with no other mechanical action needed to bring the grease to a position for skimming. In one embodiment of the invention, water may be pumped into the tank in a two-step process, although embodiments of the invention are not limited to this process. In a first step, the water is pumped or allowed to enter the tank at a high rate to bring the grease close to the top of the unit quickly. In a second step, when the contents of the tank reach a certain level, the water flow may be slowed to a rate that the operator can easily control in order to bring the grease level up to the correct level for skimming.

In an embodiment of the invention, grease is scraped from the top of the grease cap and pushed directly into a vehicle, such as a dump truck, parked adjacent to the grease removal unit. In this manner, the grease is skimmed and removed from the unit in a single process, without requiring any further pumping or other transport of the grease. In an embodiment, the unit is constructed such that the top of the unit is high enough to allow direct removal of the concentrated grease into a vehicle without requiring any other action.

In an embodiment of the invention, the concentrated grease that has been skimmed from the top of the tank is then taken to a landfill for burial or otherwise processed. The grease may be reprocessed for use in various energy and other uses. (In one example, the processed grease may be used to produce bio-diesel fuel for automobiles.

Because only the most concentrated grease at the top of the holding tank is skimmed in operation of a grease removal unit, this thus means that the removed grease may be sufficiently concentrated to be ready for disposal or reprocessing without requiring any additional water removal processes. In addition to motivations for removing as much water as possible from influent for treatment so as to minimize water that is lost, there is a maximum amount of water that can be contained in the grease to allow disposal in a landfill. The skimming process allows the operator to ensure that the grease is sufficiently concentrated when it is skimmed off so that it may be taken directly to another facility for disposal or reprocessing.

Influent is not purely a combination of grease and water, and certain amounts of non-grease matter generally will be mixed with the influent that is pumped into the grease removal unit. Settleable solids will eventually settle at the bottom of the holding tank, and can be removed by pumping out the material at the bottom of the tank or otherwise removing such material. In an embodiment of the invention, periodically a pump is run to remove solid matter from the bottom of the tank, which prevents excessive buildup of solid matter.

In an embodiment of the invention, a unit may be built partially underground, thereby reducing the likelihood of freezing in colder climates. The unit may also include heating elements to heat the contents of the tank if necessary in certain circumstances. An embodiment of a unit is constructed such that the top of the unit is sufficiently high (such as a top that is approximately 12 feet above the ground surface) to allow a dump truck or similar vehicle to park next to the unit and to allow the concentrated grease to be scraped off directly into the bed of the truck, thereby eliminating the need for any intermediary step in the removal of grease from the unit.

In embodiments of the invention, the amount of the contents of the unit may be detected by various means. The unit may include one or more sensors to sense the amount of the contents held by the unit, with the type of sensor varying in different embodiments of the invention. In one possible embodiment, a pressure transducer is placed in the holding tank of a unit, with the pressure transducer detecting head pressure in the unit. In an embodiment of the invention, a detection element of the unit allows sufficient amounts of water to remain in the unit, but will release any excess contents to prevent overflow of the tank. In this manner, the unit thus will not overflow regardless of the amount of influent that is pumped into the unit.

The processing of grease from wastewater may potentially generate odors. In an embodiment of the invention, the grease cap that forms at the top of the tank of a unit prevents the release of excessive odor. Thus, in practice a unit may be operated with minimal odor problems. The height of the unit dissipates some odors, and the presence of the concentrated grease layer largely keeps odors under control. In an embodiment of the invention, a grease cap is always maintained on the surface of the holding tank, and thus there is always a layer to minimize release of odors from the holding tank.

In an embodiment of the invention, a grease removal unit can reduce the amount of grease that enters the main wastewater system. The unit may be used to separate the grease from received influent before the grease enters the wastewater system, where the grease would otherwise be potentially mixed with millions of gallons of water. An embodiment of the invention thus may assist in improving overall wastewater treatment by removing grease in a cost effective and effective manner before influent reaches the main processing operation.

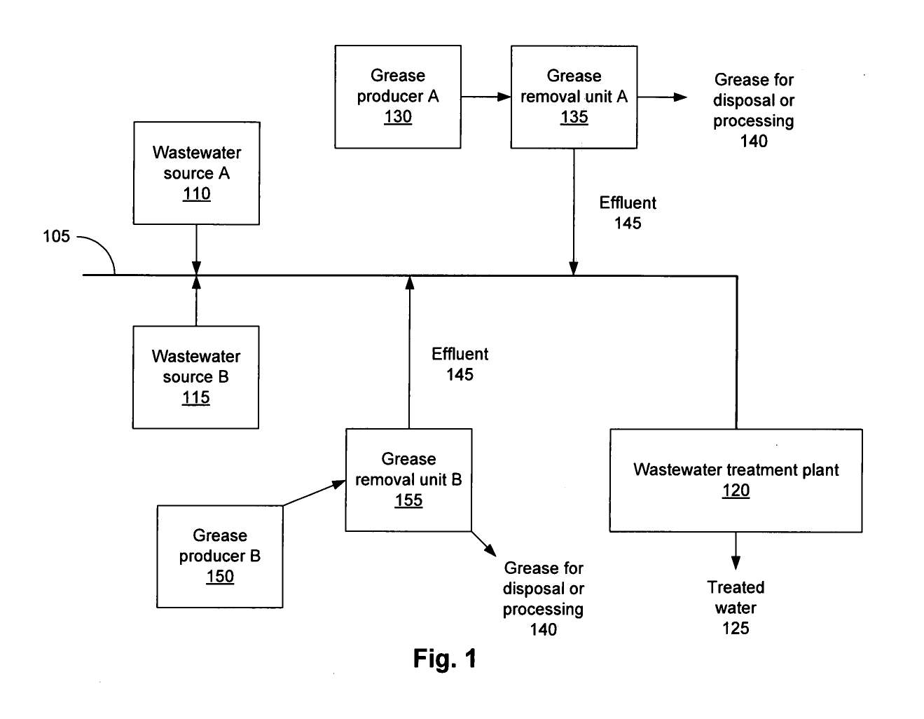

FIG. 1 is an illustration of an embodiment of a wastewater treatment system. In this illustration, a simplified system is shown to demonstrate the operation of the system without providing excessive details. A wastewater line 105 is shown, the line 105 being an abstraction of many pipes, conduits, and other connections used to gather wastewater for treatment. The wastewater line leads to a wastewater treatment plant 120, which eventually produces treated water 125. In actual operation, there may be many different lines or transport mediums, and the lines and other transport mediums may lead separately to the wastewater treatment plant 120, possibly for different types of treatment. There may be numerous wastewater sources, such as wastewater source A 110 and wastewater source B 115. Each source is location or facility that provides wastewater to the system. A source may be a home, a business, a rain runoff collector, or any other source of wastewater for treatment.

In addition to other wastewater sources, there may be a number of grease producers, such as grease producer A 130 and grease producer B 150. A grease producer may include, but is not limited to, a restaurant or other food processing operation. In an embodiment of the invention, the grease producers do not provide influent directly to the wastewater line 105, but rather direct the influent to grease removal units, such as grease removal unit A 135 and grease removal unit B 155. The grease removal units may be standalone units that could be physically separated from the wastewater treatment plant 120. The influent may be delivered to the units by truck or other method. Each grease removal unit operates to separate the received influent into wastewater 145, which can be presented to the wastewater line 105 for treatment, and concentrated grease for disposal or processing 140.

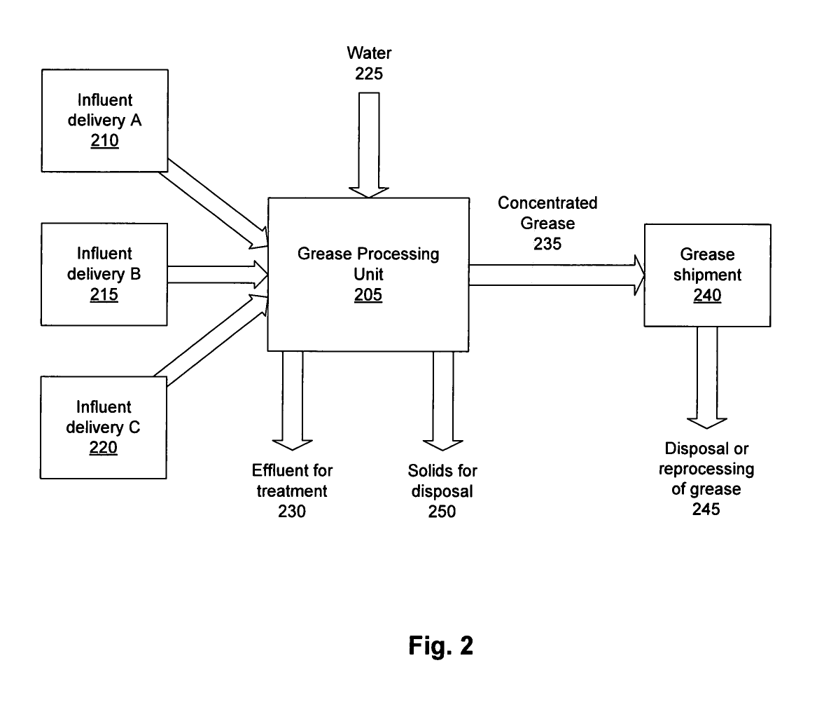

FIG. 2 illustrates an embodiment of a grease removal operation. In this illustration, a grease processing unit 205 receives a number of deliveries of influent, which may be delivered by tanker truck. The deliveries are illustrated as influent delivery A 210, influent delivery B 215, and influent delivery C 220, which are deliveries arriving at various different times. The influent deliveries are automatically handled by the grease processing unit 205, which allows delivered influent to separate and then releases effluent (wastewater) 230 for treatment. The unit operates by allowing the grease in the influent to separate and float to the top of the water. In an embodiment, the grease processing unit 205 automatically maintains a working level of materials for processing and protects against overflow by releasing additional wastewater at 230 if needed.

In an embodiment of the invention, the grease removal unit 205 also receives water 225, which is used to hydraulically raise the level of the separated grease held by the unit for removal. Separated grease 235 is skimmed from the grease removal unit 205 to a grease removal shipment 240, which may be carried away by truck or other vehicle for disposal or processing 245. In an embodiment of the invention, the separated grease 235 is removed from the grease processing unit 205 and placed into the concentrated grease shipment 240 in a single operation by skimming the grease 235 directly into the bed of a truck or similar vehicle. In an embodiment of the invention, the grease processing unit 205 may also remove solids 250 from the received influent, such as by letting such solids settle and periodically pumping such solids out of the unit 205.

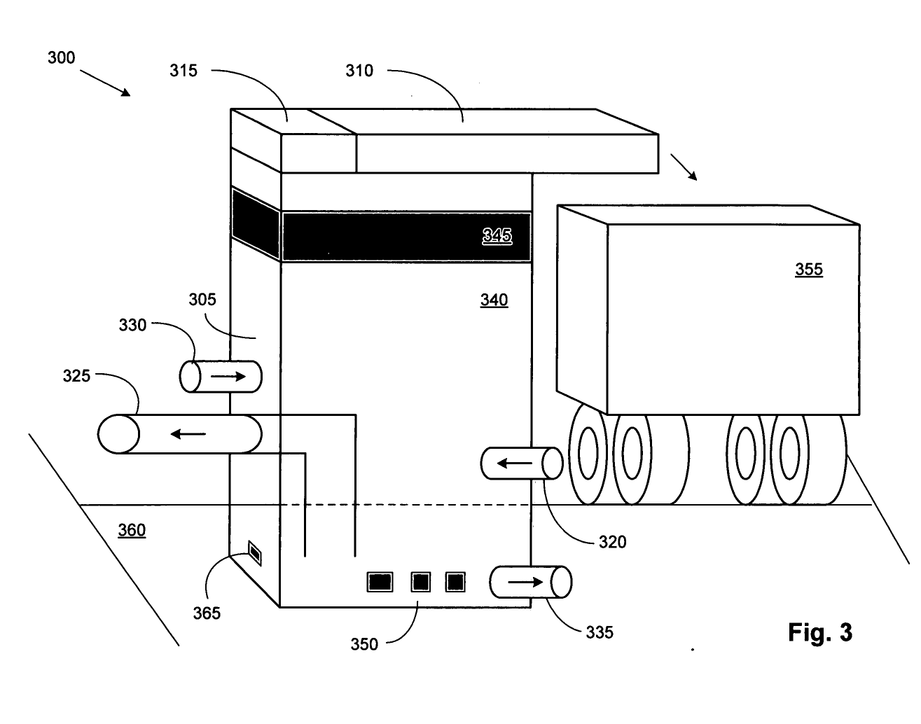

FIG. 3 is an illustration of an embodiment of a grease removal unit for wastewater treatment. In this illustration, the grease removal unit 300 includes a tank 305 to hold influent. The unit 300 may further include a scraping unit 310 for removal of grease and a control unit 315 to control the operation of the unit 300. The unit 300 may further include an influent inlet 320, an effluent outlet 325, a water inlet 330, and a solid material outlet 335. The unit 300 may include a device to determine the quantity of material in the tank, including, but not limited to, a sensor to measure contents of the tank 305, which may include a pressure transducer 365 that measures the head pressure of the tank 305. The unit 300 may be constructed partially below ground surface 360, which provides less chance of freezing the contents of the tank 305 in colder weather conditions.

In this illustration, influent may be pumped into the tank 305 through the influent inlet 320. The influent may be delivered by a motor vehicle, including but not limited to a tanker truck that has obtained influent from one or more restaurants. After the influent has been pumped into the tank 305, the contents may be allowed to separate for an initial period of time. After the period of time has elapsed, effluent (wastewater) may be decanted from the tank 305 through the effluent outlet 325 to maintain the contents of the tank 305 at a certain operating level. If excessive amounts of influent are pumped into the tank 305 through the inlet 320, the unit 300 may immediately release wastewater out of the tank 305 to prevent overflow.

The influent will separate into a layer of wastewater 340 and a layer of grease 345 on top of the water. As more influent is pumped into the tank 305, the grease 345 layer will increase in thickness over time, with the top portion of the grease layer 345 gradually containing less water. Periodically, or upon a sufficient amount of material being held in the tank 305, a portion of the grease layer 345 will be removed from the tank 305. In an embodiment, an operator will raise the grease layer 345 floating on the surface of the contents of the tank 305 using hydraulic pressure. The hydraulic pressure is generated by pumping water in through the water inlet 330 to increase the level of the wastewater layer 340 and thus force up the grease layer 345. During the period, the control 315 may close the effluent outlet 325 to prevent release of effluent. In one example, the hydraulic pressure may be implemented in two phases, with the first phase automatically raising the grease layer 345 to the proximity of the scraping unit 310 and the second phase slowly raising the grease layer 345 up further under the control of an operator.

When the hydraulic pressure has sufficiently raised the grease layer 345 such that the scraping unit 310 can reach the grease, the movement of the grease layer 345 may be halted. An operator may then engage the scraping unit 310 to scrape off the top portion of the grease layer 345. In an embodiment, the unit 300 is constructed such that a removal unit, such as a motor vehicle 355, particularly a dump truck, may be parked next to the unit 300 and the scraping unit 310 can scrape the top of the grease layer 345 directly into the bed of the motor vehicle 355. In this manner, the grease can be removed from the unit 300 without requiring any pumping or similar operation, such that the scraping and removal can be accomplished in a single process. The operator may perform multiple passes with the scraping unit until a sufficient amount of the grease layer 345 has been removed. The operator may continue scraping operations until the grease remaining at the top of the grease layer 345 contains too much water for removal, and thus should remain in the tank 305 for further concentration. After the scraping process has concluded, the unit 300 can reduce the hydraulic pressure by allowing wastewater to decant through the effluent outlet 335, thereby reducing the height of the grease layer 345, and returning the unit 300 to a state for accepting influent deliveries.

In addition, certain amounts of solid matter 350 may be contained in the influent. The solid matter 350 will generally settle to the bottom of the tank 305. The solid matter 350 is periodically removed or pumped out of the tank 305, such as through the solid matter outlet 335.

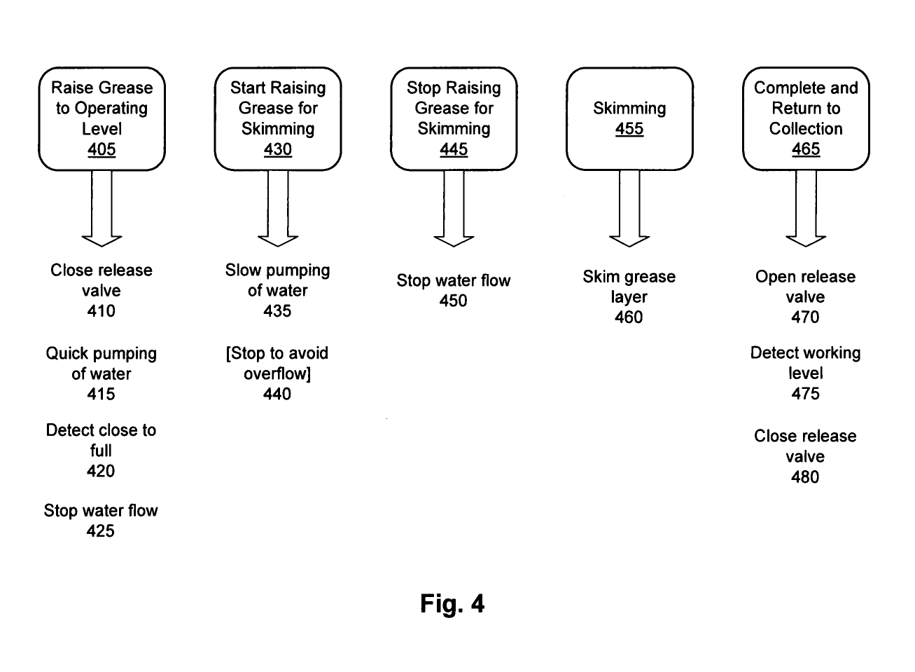

FIG. 4 is an illustration an embodiment of a user control interface for a grease removal unit. The interface shown is intended to represent an abstraction of controls provided to an operator or user and not as an actual interface system. There may be many other issues a user may address that are not illustrated here, including maintenance and testing issues. FIG. 4 assumes that the grease delivery unit is ready for skimming processes in that influent has been provided to the unit and the grease and water in the influent has had sufficient time to separate. In this illustration, the operator may direct the unit to raise the grease cap up to a skimming operation level 405. In an embodiment of the invention, the unit will close a release valve 410 to prevent the release of water from the unit. In one embodiment, the water may be added in two stages. In this first stage, water is quickly pumped into the unit 415 to push the grease up towards the top of the unit by hydraulic force. When a sensor detects that the unit is nearly full 420, the water flow is stopped 425.

The operator may then start raising the grease cap for skimming 430. In an embodiment, this process is the second stage of adding water to the unit in which water is slowly pumped into the unit 435. In an embodiment, the water flow may be automatically stopped if necessary to prevent overflow 440. When the operator determines that the level of the grease cap is sufficient for skimming, the operator will stop the process of raising the grease level 445, which results in stopping the water flow into the unit 450. The operator may then engage a skimming operation 455, by which a skimmer will skim the grease layer 460, the grease being skimmed directly into a mobile vehicle, such as a dump truck. The operator then may repeat the operations of raising the grease for skimming 430, stopping the raising process 445, and skimming the stop layer of the grease 455.

When the operator determines that the grease as the top of the unit is not sufficiently concentrated or otherwise decides to end the skimming process, the operator can complete the action and return the level of the unit to the collection state 465. This will result in opening the release valve to release the excess water 470. When a sensor detects that the unit has returned to a working level 475, the release valve is again closed 480 and the unit can again accept deliveries of influent for separation.

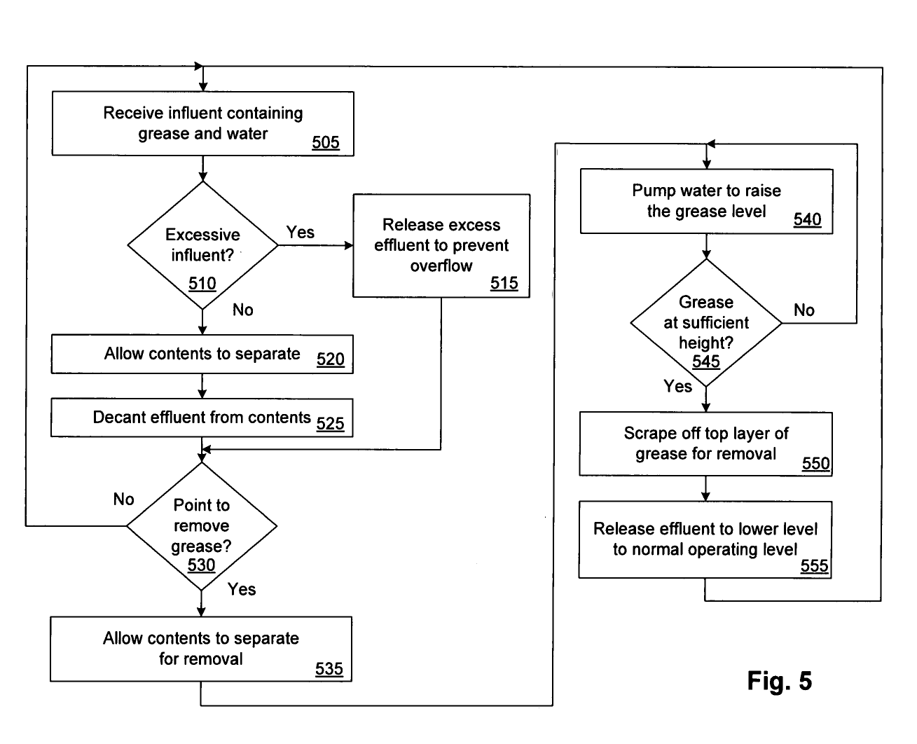

FIG. 5 is a flowchart to illustrate a process for removing grease from wastewater. In an embodiment of the invention, influent containing grease and water is received 505. If there is too much influent 510, then the excess wastewater is released to prevent overflow 515. Otherwise, the influent is allowed to separate 520 and then effluent containing predominantly water is decanted 525. The influent will separate, with the grease floating on top of the water. The process of receiving influent, allowing separation of contents, and decanting of effluent may be repeated multiple times. If a point for removal of grease from the influent is reached 530, such as a periodic event (every week or other time period), then the influent is allowed to separate for a certain time period 535, which will increase the concentration of the grease.

Water is pumped or released into the tank 540, thereby pushing up the grease using hydraulic pressure. When the grease reaches a sufficient height 545, the top layer of grease is scraped off for removal into a vehicle 550, such as a motor vehicle, which can then take the grease for disposal. Effluent is released to lower the unit contents to a normal operating level 555, and allowing the process of acceptance of influent deliveries to continue 505.

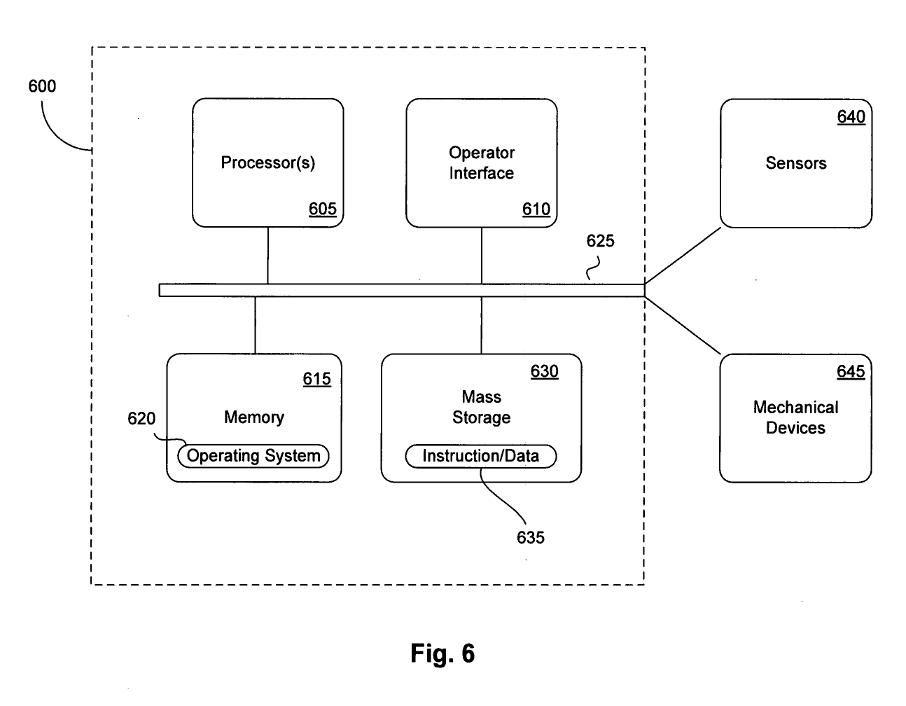

FIG. 6 is an illustration of a control unit that may be utilized in an embodiment. While the control unit is illustrated as a single unit in this illustration, the processes may be divided into multiple control units. As illustrated, a control unit 600 can execute stored instructions for automatic operation or can respond to instructions from an operator. The control unit illustrated in FIG. 6 is only one of various possible system architectures, and is a simplified illustration that does include many well-known elements. A control unit 600 may include one or more processors 605 and memory 615 coupled to a bus system 625. The bus system 625 is an abstraction that represents any one or more separate physical buses, point-to-point connections, or both connected by appropriate bridges, adapters, or controllers. The bus system 625 may include, for example, a system bus, a Peripheral Component Interconnect (PCI) bus, a HyperTransport or industry standard architecture (ISA) bus, a small computer system interface (SCSI) bus, a universal serial bus (USB), or an Institute of Electrical and Electronics Engineers (IEEE) standard 1394 bus, sometimes referred to as “Firewire”. (“Standard for a High Performance Serial Bus” 1394-1995, IEEE, published Aug. 30, 1996, and supplements thereto)

As illustrated in FIG. 6, the processors 605 are central processing units (CPUs) of the control unit 600 and control the overall operation of the control unit 600. The processors 605 execute software stored in memory 615. A processor 605 may be, or may include, one or more programmable general-purpose or special-purpose microprocessors, digital signal processors (DSPs), programmable controllers, application specific integrated circuits (ASICs), programmable logic devices (PLDs), or the like, or a combination of such devices.

Memory 615 is or includes the main memory of the computer system 600. Memory 615 represents any form of random access memory (RAM), read-only memory (ROM), flash memory, or the like, or a combination of such devices. Memory 610 stores, among other things, the operating system 620 of the control unit 600.

The control unit 600 also includes an operator interface 610 by which the operator may provide instructions to the unit, and by which the unit may provide certain information to the operator. The operator interface may utilize any known technology, including a viewing screen, gauges, buttons, and switches. Also connected to the processors 605 through the bus system 625 are one or more internal mass storage devices 625. Internal mass storage devices 630 may be or may include any conventional medium for storing large volumes of instructions and data.

One or more sensors 640 may be connected to the control unit 600. The sensors 640 may, for example, detect the quantity of material contained in the unit for processes. One or more mechanical devices 645 may be connected to the control unit 600 to be controlled by the control system 600. The mechanical devices may include a skimmer to skim grease from the unit, a pump to pump water into the unit, a release valve to release water from the unit, and a pump to remove solid material from the unit.

In the description above, for the purposes of explanation, numerous specific details are set forth in order to provide a thorough understanding of the present invention. It will be apparent, however, to one skilled in the art that the present invention may be practiced without some of these specific details. In other instances, well-known structures and devices are shown in block diagram form.

Many of the methods are described in their most basic form, but processes can be added to or deleted from any of the methods and information can be added or subtracted from any of the described messages without departing from the basic scope of the present invention. It will be apparent to those skilled in the art that many further modifications and adaptations can be made. The particular embodiments are not provided to limit the invention but to illustrate it. The scope of the present invention is not to be determined by the specific examples provided above but only by the claims below.

It should also be appreciated that reference throughout this specification to “one embodiment” or “an embodiment” means that a particular feature may be included in the practice of the invention. Similarly, it should be appreciated that in the foregoing description of exemplary embodiments of the invention, various features of the invention are sometimes grouped together in a single embodiment, figure, or description thereof for the purpose of streamlining the disclosure and aiding in the understanding of one or more of the various inventive aspects. This method of disclosure, however, is not to be interpreted as reflecting an intention that the claimed invention requires more features than are expressly recited in each claim. Rather, as the following claims reflect, inventive aspects lie in less than all features of a single foregoing disclosed embodiment. Thus, the claims are hereby expressly incorporated into this description, with each claim standing on its own as a separate embodiment of this invention.

What is claimed is:

1. A grease processing unit comprising:
a tank to hold influent, the tank comprising a top, a bottom, and one or more sides, the influent comprising grease and water;
a first inlet in a side of the tank to allow influent to be pumped into the tank;
a second inlet in a side of the tank to allow water into the tank;
an outlet in the side of the tank, the outlet to allow effluent to be released out of the tank; and
a control unit, the control unit to control the operation of the grease processing unit.

2. The unit of claim 1, further comprising a skimmer to skim a portion of a grease layer from the top of the tank.

3. The unit of claim 1, wherein the control unit allows water in the second inlet to raise the grease layer to the level of the scraper.

4. The unit of claim 3, wherein the grease layer is raised by hydraulic pressure.

5. The unit of claim 3, wherein the skimmer is to skim the grease into a mobile unit for removal.

6. The unit of claim 5, wherein the mobile unit is a motor vehicle.

7. The unit of claim 1, wherein the top of the tank is open.

8. The unit of claim 1, wherein a motor vehicle is to pump influent into the tank using the first inlet.

9. The unit of claim 1, wherein a human operator controls certain functions of the control unit.

10. The unit of claim 1, wherein the control unit automatically maintains a level of contents in the tank within a certain range.

11. The unit of claim 10, wherein the control unit allows a delivery of influent to separate for a certain time period before releasing water through the outlet to maintain the level of the contents of the tank.

12. The unit of claim 10, wherein the control unit automatically releases effluent through the outlet if necessary to prevent overflow.

13 The unit of claim 1, further comprising a pump to remove solid material from the bottom of the tank.

14. The unit of claim 1, further comprising a sensor to detect the amount of material in the tank.

15. The unit of claim 14, wherein the sensor comprises a pressure transducer.

16. The unit of claim 1, wherein the tank is partially below a ground level.

17. A wastewater system comprising:
a wastewater line;
a wastewater treatment plant receiving wastewater from the wastewater line; and
a grease separation unit coupled with the wastewater line, the grease separation unit separating influent into grease and wastewater, the grease separation unit providing the wastewater to the wastewater line and providing the separated grease to vehicles for removal.

18. The wastewater system of claim 17, wherein the grease separation unit is located in a different location than the wastewater treatment plant.

19. The wastewater system of claim 17, wherein the grease separation unit separates the grease and water before the grease reaches the wastewater treatment plant.

20. A method of separating grease from wastewater comprising:
receiving a quantity of influent, the influent comprising grease and wastewater;
automatically holding the received influent for a time period;
upon expiration of the time period, releasing enough wastewater to maintain a certain level of contents;
allowing the influent to separate into a top layer of grease and a bottom layer of water; and
pushing the layer of grease upward using hydraulic pressure for removal of the grease.

21. The method of claim 20, further comprising automatically releasing wastewater to prevent an overflow of contents.

22. The method of claim 20, wherein removal of the grease comprises scraping a top portion of the grease layer.

23. The method of claim 22, wherein scraping the top portion of the grease layer comprises scraping the grease into a mobile unit for removal of the grease.

24. The method of claim 23, wherein scraping the top portion of the grease layer removes the grease in a single operation.
